(19) United States
(12) Patent Application Publication
(10) Pub. No.: US 2012/0284130 A1
(43) Pub. Date: Nov. 8, 2012

(54) BARCODE CHECKOUT AT POINT OF SALE

(75) Inventors: Scott Lewis, Omaha (CA); Victor Estrada, (US)

(73) Assignee: EBAY, INC., SAN JOSE, CA (US)

(21) Appl. No.: 13/458,826

(22) Filed: Apr. 27, 2012

Related U.S. Application Data
(60) Provisional application No. 61/482,965, filed on May 5, 2011.

(51) Int. Cl. G06Q 20/20

(52) U.S. Cl. 705/16

(57) ABSTRACT

A consumer at a merchant store can scan, with a user mobile device, a barcode generated by the merchant to make a payment. The information contained in the barcode include a merchant identifier, a total amount, and information about the items purchased. A payment provider processes the information received from the user device and notifies the merchant if the payment is approved. A digital receipt may be generated and stored for future use.

### CROSS REFERENCE TO RELATED APPLICATION

This application claims priority to U.S. Provisional Patent Application Ser. No. 61/482,965, filed May 5, 2011.

### BACKGROUND

1. Field of the Invention

The present invention generally relates to financial transactions, and in particular, to payments at a point of sale (POS).

2. Related Art

When shopping at a store or other physical point of sale location, the user is typically provided numerous options for payment, such as cash, check, debit card, and credit card. However, as more and more consumers are using smart phones, they may be less inclined to pay with such funding sources from a physical wallet or purse. Furthermore, such funding sources may be unsafe or unsecure, e.g., possibility of a consumer losing cash or check forgeries.

Payment providers, such as PayPal, Inc. of San Jose, Calif., offer payment services to consumers with added security. As such, an increasing number of consumers are using third party payment providers to make payments. This is especially prevalent with online transactions.

There is still a large market for offline transactions at physical point of sale (POS) locations, such as stores, malls, etc. Consumers still make a majority of purchases at a physical POS with conventional funding instruments from a physical wallet, but may desire the advantages of paying through a smart phone or other mobile device. While merchants are making efforts to allow payments from entities such as PayPal, there is a cost associated with upgrading or changing merchant software and transaction terminals/devices. As such, some merchants may not spend the money to do this and thus would not be able to accept certain types of payments. This may result in consumer inconvenience and/or lost sales.

Therefore, a need exists to provide the consumer and the merchant an easy and inexpensive way to make payments at a physical POS using a mobile device.

### SUMMARY

According to one embodiment, a consumer goes through a checkout process at a POS, such as having the items scanned. Once the scanning is completed (either by a cashier or by the consumer), the consumer selects a payment provider for payment with the merchant. Note that in different embodiments, the consumer can select the payment provider at different points in time, including at the beginning of the scanning or during the scanning. The merchant system creates a barcode or other scannable code or identifier corresponding to the transaction.

After all items have been scanned, the consumer access or logs into a payment provider app on the consumer's device, such as a smart phone. Once logged in, the consumer selects an option to make a payment at the POS. The consumer then scans or otherwise captures the barcode from the merchant, such as scanning a printed receipt or barcode from the merchant using the consumer's smart phone. The transaction information captured from the barcode is transmitted and processed by the payment provider.

If the payment request is approved, the payment provider may send a request to the consumer device to approve the payment. If approved by the consumer, the merchant may communicate with the payment provider or a database storing information from the payment provider to determine whether the payment has been approved. Once notified accordingly, the merchant completes the transaction, and funds are credited to the merchant account. A digital receipt of the transaction may be stored on the consumer device and/or with the payment provider.

Consequently, consumers are allowed the freedom to not be tied to a device that transmits personal information via an NFC chip or to a limited number of devices. The merchants would not need any expensive hardware as this may be all done via APIs within their POS system. The consumer has the freedom to use their mobile device to make a payment without having to set up an “account” with the merchant first.

These and other features and advantages of the present invention will be more readily apparent from the detailed description of the embodiments set forth below taken in conjunction with the accompanying drawings.

### BRIEF DESCRIPTION OF THE FIGURES

FIG. 1 is a flowchart showing a process for making a payment at a POS according to one embodiment;

FIG. 2 is a flowchart showing process for handling a payment at a POS according to another embodiment;

FIG. 3 is block diagram of a networked system suitable for implementing the process of FIGS. 1 and 2 according to an embodiment; and

FIG. 4 is a block diagram of a computer system suitable for implementing one or more components in FIG. 3 according to one embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

There are tens of thousands of brick and mortar locations that use POS software to record each “sale” with a barcode that stores the transaction details including the amount of each sale. This concept will allow a consumer to use a mobile device to make a payment by scanning the barcode, such as a QR code or other scannable code, generated by a merchant's POS system. This does not use NFC technology, magnetic device or employ a “pre-paid” model, but instead allows for a third-party payment platform to use a mobile application (App) on a mobile device to authorize and settle a payment in real-time at a brick and mortar location for a retail transaction.

The app could work with POS software companies' code bases to allow the POS software to communicate the amount of the sale and other information contained in the barcode to a central database that the app can tap into via a specific set of APIs. The method of calling up the payment amount could be done via a mobile app to scan the bar code on a paper receipt or terminal at the physical store location. This could initiate an API call to the POS network which would return the amount, merchant identifier, such as a name, and any other desired information. The buyer may then select a funding source and approve the payment. The app could send a completed payment response to the database, and the store clerk or self-checkout kiosk could run a call which would ping the database for the payment status of that transaction. If successful, the sale is completed and the buyer gets to enjoy their merchandise/service, and the payment settles into the merchant's account immediately. The app may store the barcode so the buyer has a record of the transaction which can be recalled if the buyer needed to exchange, return or request a refund for an item on that sale.

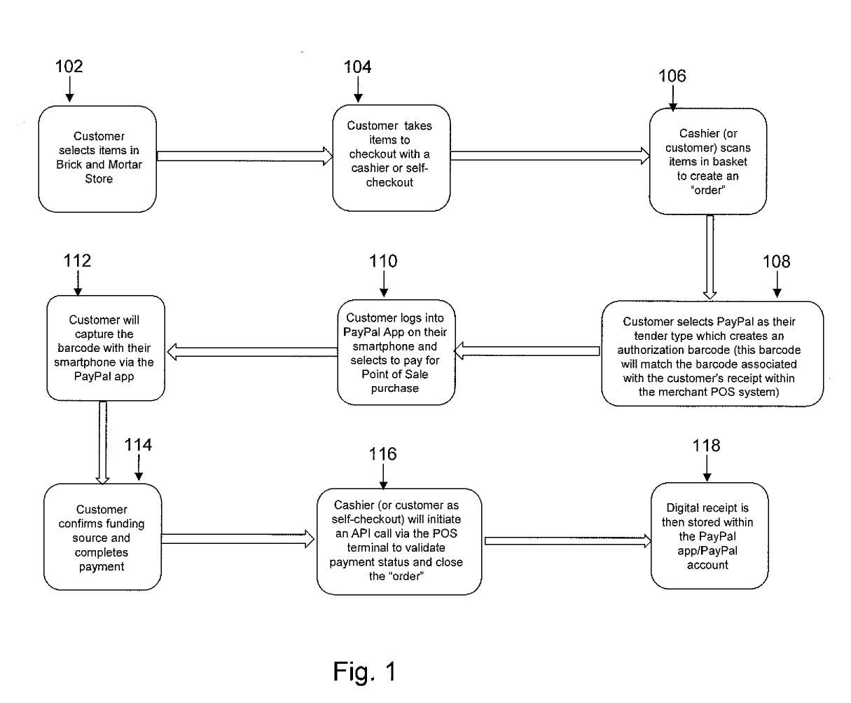

FIG. 1 is a flowchart showing a process for making a payment at a POS according to one embodiment. At step 102, the customer, consumer, or user selects items for purchase from a POS, such as a merchant store, location, or site. For example, the customer may place desired items into a basket or cart. In another example, the customer may select desired items electronically or have items retrieved/delivered by a store clerk or employee.

Next, at step 104, the customer takes the selected items to a checkout with a cashier or to a self-checkout to start the payment or checkout process. This step may be skipped if the items are already at the checkout.

The items are then scanned, either by the cashier or the consumer, at step 106. Scanning captures information about the item, such as description and price. The scanning continues until all items have been scanned. Scanning can be with conventional methods, using standard checkout equipment and software. For example, a cashier or the consumer may move each item across a UPC barcode scanner. As each item is scanned, the price and description, along with any other information about the item, is captured in the merchant system. In another embodiment, the consumer can scan items throughout the store, such as using a camera or scanner feature on the consumer mobile device. In this case, one or more of steps 102, 104, and 106 can be combined. As the consumer walks through the store, the consumer may scan and place items in a basket/cart or scan the items and have the scanned items retrieved/delivered to the checkout counter.

Once the items are scanned, the consumer selects the payment provider for payment, at step 108. Note that in different embodiments, the selection can be at the beginning, during, or end of the scanning. Selection can be through the consumer device, a merchant device, or a third party device (such as a terminal provided by the payment provider). For example, the user select a “Pay with PayPal” button or link on the appropriate device. The information is communicated to the payment provider by the device. After the payment provider is selected as the source for payment, an authorization barcode, which may match the barcode associated with the customer's receipt within the merchant system, is created. This allows the payment provider to associate the current transaction with the user and merchant. The barcode may be a QR code, other two-dimensional codes, or other scannable codes.

Next, at step 110, the consumer logs into the payment provider site, such as through the consumer device like a smart phone, and selects a POS payment option. Logging in may include entering a PIN or password, along with a user identifier such as a user name or email address. However, in some embodiments, the user identifier is automatically conveyed to the payment provider, such as through a consumer device ID or phone number. The login information is communicated to the payment provider. The payment provider uses this information to locate and access the consumer's account and prepare for a POS purchase.

After successful login, the consumer may be notified, through the user device, to scan or otherwise capture the barcode or other transaction identifier with the user device. The consumer then captures the transaction identifier, at step 112. Examples of capturing include scanning or taking a photo of a barcode or 2-D code on a receipt or invoice (paper or electronic). For example, the user may be presented with a paper receipt having a printed barcode, or the user may be shown an electronic barcode on a merchant or third party device. The display, in either case, may include details of the transaction, such as total amount due and items purchased. The captured data is processed, either by the user device or by the payment provider, to determine details of the transaction, including items purchased and total cost. Other details may include merchant information, such as a merchant account identifier.

The transaction details are communicated to the payment provider for processing to determine whether the payment is to be approved or denied. Processing may include determining whether the transaction amount and/or other details are within the consumer's account settings and performing fraud/risk analysis, such as determining the location of the transaction, the location of the user device, the amount of purchase, the type of purchase, etc. and determining whether the transaction should be denied or require additional verification/authentication.

If approved, the payment provider may request the consumer confirm the payment. The consumer may confirm the payment, at step 114, by selecting a “confirm,” “pay,” or other similar button or link on the consumer device. The consumer may be shown details of the payment, such as recipient name and total. This confirmation is communicated to the payment provider, who then processes the payment, at step 114. Processing may include debiting an appropriate amount from the consumer account and crediting an appropriate amount in a merchant account.

Next, at step 116, the merchant or consumer may send a call or request, such as to a database storing the transaction information, for a status of the transaction payment. The call or request may be sent from the merchant device, the consumer device, or a third party device. The merchant may then be notified on the merchant device, through a return call, such as from the database, that the payment has been completed. In other embodiments, the merchant and/or consumer may be notified of a successful payment directly by the payment provider after the consumer has confirmed the payment in step 114.

After the items have been paid for, a digital receipt may be stored, at step 118, for later use or reference. The receipt may be stored on the consumer's device or in the consumer's account with the payment provider, such as in a cloud or on a merchant server or database. Thus, the consumer may be able to retrieve details of the transaction, such as specific items purchased, price, date, and merchant information, either on the user mobile device or through the user account page with the payment provider. Note that one or more of the above steps may be combined, omitted, or performed in a different sequence as desired.

As a result, the consumer is able to make a purchase through a payment provider service at a merchant location using the consumer's mobile device and without the merchant having to do costly upgrades or install costly new software or devices. This enables the consumer to use the mobile device for payment at more merchant locations, including smaller businesses that would not be able to afford significant modifications to their payment processing systems.

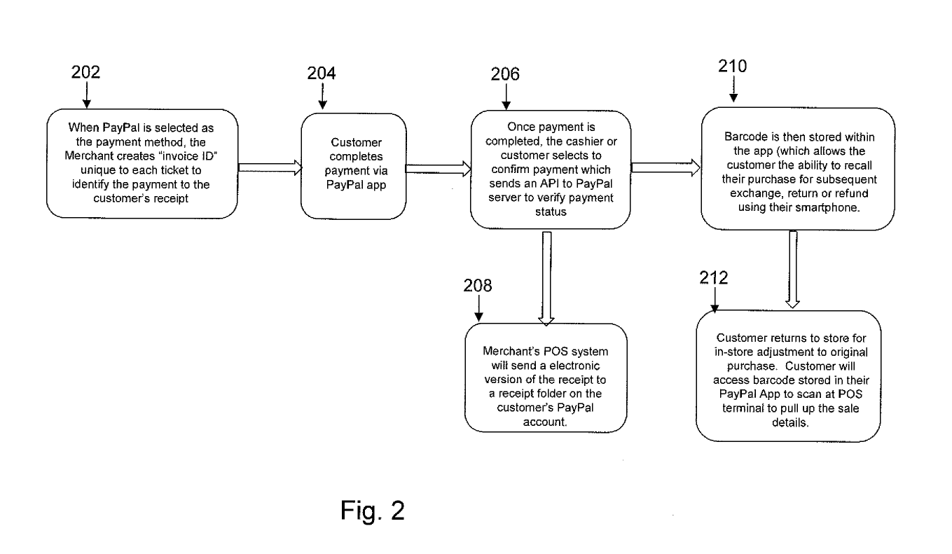

FIG. 2 is a flowchart showing a process for handling a payment at a POS according to another embodiment. At step 202, the merchant creates an invoice or transaction identifier associated with the transaction when the user selects the payment provider as the payment source. As described above, this can be before, during, or after the items are scanned. As items are scanned, a receipt is created and updated. When scanning is completed, the receipt includes a total amount due and may be associated with the transaction identifier.

The payment provider receives an indication from the consumer, such as through a log in and selection process, that the consumer wishes to make the payment through the payment provider using a POS payment option. In another embodiment, the indication may be received through a merchant device, such as by the merchant or the consumer selecting a button on the device. The payment provider then requests the consumer, again such as through the consumer device, to capture a transaction indicator, such as a barcode or 2-D barcode. Once captured, the information is communicated to the payment provider, who processes the payment request. Details of the results and/or the transaction may be maintained with the payment provider and/or stored in a database, cloud, server, or other mechanism accessible by the payment provider and/or the merchant.

After all items have been scanned and totaled, the consumer completes the payment at step 204, which may include viewing details of the transaction, getting authenticated (if not already done so), submitting a request for payment to the payment provider, and confirming an approved payment. The confirmation is communicated to the payment provider, who may again store the completed transaction details, such as in the database or in its own system.

The payment provider may notify the merchant and/or consumer of a completed payment proactively or in response to a call or request from the merchant and/or consumer, at step 206. This may be through a merchant device, such as a POS terminal or pad, a user device, such as a smart phone, or a third party device. Once the merchant receives payment confirmation, the merchant may finalize the digital receipt and send it to the consumer and/or payment provider, which can be stored in the consumer device and/or by the payment provider.

In addition to or alternatively from storing the digital receipt, the consumer may store the barcode associated with the transaction, at step 210. The barcode may be accessed from the consumer device, such as through a search by transaction date, merchant type, dollar amount, etc. This barcode enables the consumer to obtain details of the transaction without keeping an itemized receipt.

Thus, if the consumer wishes to return one or more items from the purchase, the consumer accesses the barcode, at step 212. The barcode is then shown on a display of the consumer device. Note that one or more of the above steps may be combined, omitted, or performed in a different sequence as desired. The consumer returns to the store or another store of the merchant and shows the barcode to the merchant. The merchant scans or otherwise reads the barcode to access details of the transaction, which have been stored with the merchant. For example, after scanning the barcode, the merchant may see an itemized receipt on a merchant device. Items for return are scanned and matched against the receipt. If the item can be returned and corresponds to a purchase from the merchant, the merchant can process the refund according to conventional methods.

The digital receipt may be modified, showing one or more returns, along with details on the return, such as when they were made. The new digital receipt is then associated with the barcode or a new barcode may be generated (in which case, the consumer may be provided with and store this new barcode). The refund details may be communicated to the payment provider, who then credits the consumer account and debits the merchant account accordingly.

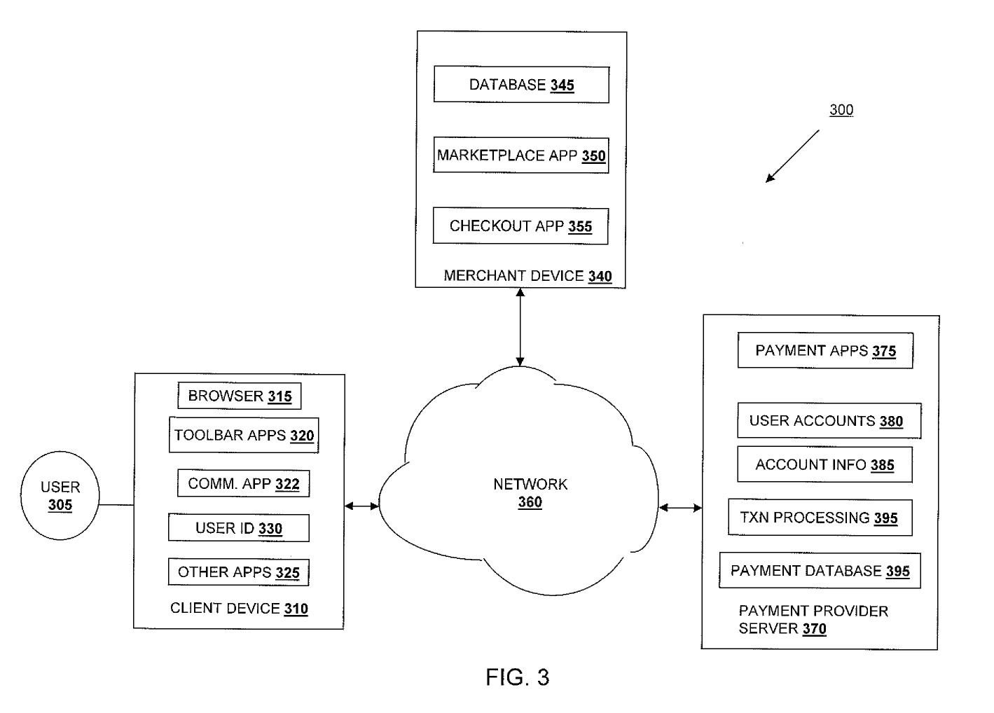

FIG. 3 is a block diagram of a networked system 300 configured to handle a financial transaction between a payment recipient (e.g., merchant) and a payment sender (e.g., user or consumer), such as described above, in accordance with an embodiment of the invention. System 300 includes a user device 310, a merchant device 340, and a payment provider server 370 in communication over a network 360. Payment provider server 370 may be maintained by a payment provider, such as PayPal, Inc. of San Jose, Calif. A user 305, such as the sender or consumer, utilizes user device 310 to perform a payment transaction with merchant device 340 using payment provider server 370. Merchant device 340 may be a server managed by the merchant, a POS device handling a payment at a merchant location, or other appropriate device enables the merchant to process a purchase by user 305.

User device 310, merchant device 340, and payment provider server 370 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 300, and/or accessible over network 360.

Network 360 may be implemented as a single network or a combination of multiple networks. For example, in various embodiments, network 360 may include the Internet or one or more intranets, landline networks, wireless networks, and/or other appropriate types of networks.

User device 310 may be implemented using any appropriate hardware and software configured for wired and/or wireless communication over network 360. For example, in one embodiment, the user device may be implemented as a personal computer (PC), a smart phone, personal digital assistant (PDA), laptop computer, and/or other types of computing devices capable of transmitting and/or receiving data, such as an iPad™ from Apple™.

User device 310 may include one or more browser applications 315 which may be used, for example, to provide a convenient interface to permit user 305 to browse information available over network 360. For example, in one embodiment, browser application 315 may be implemented as a web browser configured to view information available over the Internet. User device 310 may also include one or more toolbar applications 320 which may be used, for example, to provide client-side processing for performing desired tasks in response to operations selected by user 305. In one embodiment, toolbar application 320 may display a user interface in connection with browser application 315 as further described herein.

User device 310 may further include other applications 325 as may be desired in particular embodiments to provide desired features to user device 310. For example, other applications 325 may include security applications for implementing client-side security features, programmatic client applications for interfacing with appropriate application programming interfaces (APIs) over network 360, or other types of applications. Applications 325 may also include email, texting, voice and IM applications that allow user 305 to send and receive entails, calls, and texts through network 360, as well as applications that enable the user to communicate, place orders, and make payments through the payment provider as discussed above. User device 310 includes one or more user identifiers 330 which may be implemented, for example, as operating system registry entries, cookies associated with browser application 315, identifiers associated with hardware of user device 310, or other appropriate identifiers, such as used for payment/user/device authentication. In one embodiment, user identifier 330 may be used by a payment service provider to associate user 305 with a particular account maintained by the payment provider as further described herein. A communications application 322, with associated interfaces, enables user device 310 to communicate within system 300.

Merchant device 340 may be maintained, for example, by a merchant or seller offering various products and/or services in exchange for payment to be received over network 360. Generally, merchant device 340 may be maintained by anyone or any entity that receives money, which includes charities as well as retailers and restaurants. Merchant device 340 includes a database 345 identifying available products and/or services (e.g., collectively referred to as items) which may be made available for viewing and purchase by user 305, including receipts associated with identifiers, such as barcodes. Accordingly, merchant device 340 also includes a marketplace application 350 which may be configured to serve information over network 360 to browser 315 of user device 310. In one embodiment, user 305 may interact with marketplace application 350 through browser applications over network 360 in order to view various products, food items, or services identified in database 345.

Merchant device 340 also includes a checkout application 355 which may be configured to facilitate the purchase by user 305 of goods or services identified by marketplace application 350 or presented to the merchant at the POS. Checkout application 355 may be configured to accept payment information from or on behalf of user 305 through payment service provider server 370 over network 360. For example, checkout application 355 may receive and process a payment confirmation from payment service provider server 370, as well as transmit transaction information to the payment provider and receive information from the payment provider (e.g., a transaction ID). Checkout application 355 may also be configured to accept one or more different funding sources for payment, as well as generate a barcode and digital receipt for the transaction.

Payment provider server 370 may be maintained, for example, by an online payment service provider which may provide payment between user 305 and the operator of merchant device 340. In this regard, payment provider server 370 includes one or more payment applications 375 which may be configured to interact with user device 310 and/or merchant device 340 over network 360 to facilitate the purchase of goods or services by user 305 of first user device 310 at a merchant POS as discussed above.

Payment provider server 370 also maintains a plurality of user accounts 380, each of which may include account information 385 associated with individual users. For example, account information 385 may include private financial information of users of devices such as account numbers, passwords, device identifiers, user names, phone numbers, credit card information, bank information, or other financial information which may be used to facilitate online transactions by user 305. Advantageously, payment application 375 may be configured to interact with merchant device 340 on behalf of user 305 during a transaction with checkout application 355 to track and manage purchases made by users and which funding sources are used.

A transaction processing application 390, which may be part of payment application 375 or separate, may be configured to receive information from a user device and/or merchant device 340 for processing and storage in a payment database 395. Transaction processing application 390 may include one or more applications to process information from user 305 for processing an order and payment at a merchant POS as described herein. As such, transaction processing application 390 may store details of an order associated with a phrase from individual users. Payment application 375 may be further configured to determine the existence of and to manage accounts for user 305, as well as create new accounts if necessary.

Payment database 395 may store transaction details from completed transactions, including barcodes and/or details of the transaction. Such information may also be stored in a third party database accessible by the payment provider and/or the merchant.

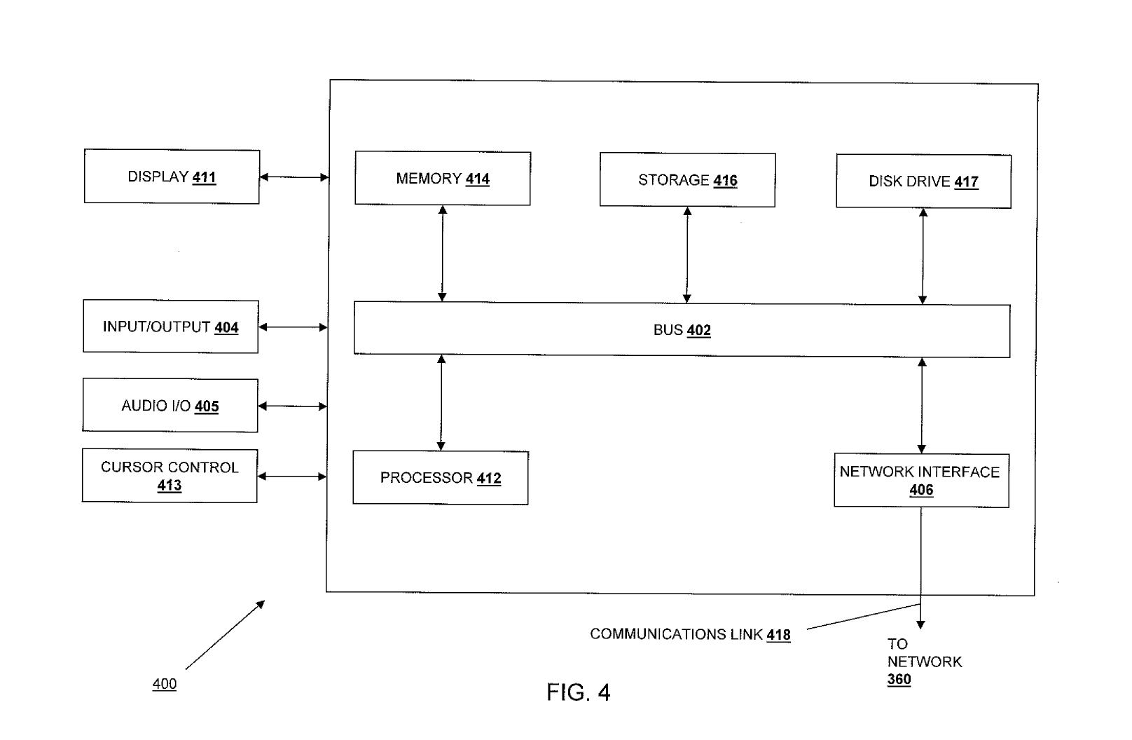

FIG. 4 is a block diagram of a computer system 400 suitable for implementing one or more embodiments of the present disclosure. In various implementations, the user device may comprise a personal computing device (e.g., a personal computer, laptop, smart phone, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant device, or a payment provider server via network 360. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system, comprising:
a non-transitory memory storing user account information, wherein the information comprises a user account identifier and a transaction identifier; and
one or more processors for
receiving, by a payment provider, a desire for a user to pay at a point of sale for a financial transaction a merchant using an account with the payment provider and a user device;
receiving information from an identifier captured by the user device, wherein the identifier corresponds to details from the financial transaction;
processing the financial transaction; and
communicating an approval for payment to the merchant.

2. The system of claim 1, wherein the information further comprises a digital receipt corresponding to the payment.

3. The system of claim 1, wherein the one or more processors further receives log in information from the user.

4. The system of claim 1, wherein the identifier is a barcode or 2-D code.

5. The system of claim 1, wherein the identifier is associated with a digital receipt of the transaction.

6. The system of claim 5, wherein the digital receipt is stored with the merchant.

7. The system of claim 1, wherein the communicating is directly to the merchant.

8. The system of claim 1, wherein the communicating is indirectly through information stored in a database.

9. The system of claim 1, wherein the communicating is in response to a call from the merchant.

10. The system of claim 5, wherein the digital receipt is stored in the user device.

11. The system of claim 5, wherein the digital receipt is stored with the payment provider.

12. The system of claim 1, wherein the identifier is captured by scanning with the user device.

13. A non-transitory computer-readable medium comprising a plurality of machine-readable instructions which, when executed by one or more processors, are adapted to cause the one or more processors to perform a method comprising
receiving, by a payment provider, a desire for a user to pay at a point of sale for a financial transaction a merchant using an account with the payment provider and a user device;
receiving information from an identifier captured by the user device, wherein the identifier corresponds to details from the financial transaction;
processing the financial transaction; and
communicating an approval for payment to the merchant.

14. The non-transitory computer-readable medium of claim 13, wherein the identifier is a barcode or 2-D code.

15. The non-transitory computer-readable medium of claim 13, wherein the identifier is associated with a digital receipt of the transaction.

16. The non-transitory computer-readable medium of claim 13, wherein the communicating is in response to a call from the merchant.

17. The non-transitory computer-readable medium of claim 13, wherein the identifier is captured by scanning with the user device.

18. A method of processing a financial transaction, comprising:
receiving, electronically by a processor of a payment provider, a desire for a user to pay at a point of sale for a financial transaction a merchant using an account with the payment provider and a user device;
receiving, by the processor, information from an identifier captured by the user device, wherein the identifier corresponds to details from the financial transaction;
processing the financial transaction; and
communicating, electronically, an approval for payment to the merchant.

19. The method of claim 18, wherein the identifier is a barcode or 2-D code.

20. The method of claim 18, wherein the identifier is associated with a digital receipt of the transaction.

21. The method of claim 18, wherein the communicating is in response to a call from the merchant.

22. The method of claim 18, wherein the identifier is captured by scanning with the user device.
